(19) United States
(12) Patent Application Publication
(10) Pub. No.: US 2010/0105357 A1
(43) Pub. Date: Apr. 29, 2010

(54) APPARATUS AND METHOD FOR RENEWING A KEY, COMPUTER READABLE MEDIUM THEREOF AND WIRELESS NETWORK COMPRISING THE SAME

(75) Inventors: FRANK CHEE-DA TSAI, Taipei (TW); CHIEN-CHIEN CHIU, Yonghe City (TW); I-HUNG LIN, Taipei (TW); HUNG-MIN SUN, Taichung (TW); SHIH-YING CHANG, Nantou City (TW); CHIEH HSING, Xindian City (TW); CHI-YI KAO, Wanly Town (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/337,015

(22) Filed: Dec. 17, 2008

(30) Foreign Application Priority Data
Oct. 24, 2008 (TW) 097140881

(51) Int. Cl. H04W 12/04

(52) U.S. Cl. 455/411

(57) ABSTRACT

An apparatus and method for renewing a key, a computer readable media thereof, and a wireless network comprising the same are provided. The method is adapted to the first base station. The first base station belongs to a wireless network. The first base station uses a first key and has a first coverage. The method comprises the following steps: determining that the mobile device moves from the first coverage to the second coverage of a second base station; determining that the login time of the mobile device is later than the renewing time of the first key; renewing the first key; and sending the first key to the mobile device.

This application claims the benefit of priority based on Taiwan Patent Application No. 097140881 filed on Oct. 24, 2008, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a key renewing apparatus and method, a computer readable medium thereof and a wireless network comprising the key renewing apparatus. In particular, the present invention relates to a key renewing apparatus and method capable of reducing the number of real-time key renewing operations, a computer readable medium thereof and a wireless network comprising the key renewing apparatus.

2. Descriptions of the Related Art

With the advancement of modern science and technology, people rely on mobile devices more to communicate with each other Mobile devices that are currently available operate in mostly in a respective specific wireless network, such as the Global System for Mobile Communications (GSM) system, the Wideband Code Division Multiple Access (WCDMA) system, the Worldwide Interoperability for Microwave Access (WiMax) system, or the like. These wireless networks all provide a multicast function to cater for the individual needs of particular users. To transmit a message through multicast, a key must be used. All mobile devices in this group are provided with this key to decode the message, while those outside this group are not provided with the key. Therefore, even if those outside this group can acquire the message, there is no way to decode the message.

Most of the wireless networks consist of a plurality of base stations. As a result, it is important to manage the key of a particular group when a mobile device of this group moves across different base station coverage. A solution of the prior art is to provide each base station with a key. However, when a mobile device enters the coverage of a base station, the base station must immediately renew the key and then transmit the renewed key to all mobile devices in this group. Additionally, when a mobile device leaves the coverage of the base station, the base station also must immediately renew the key and transmit the renewed key to all mobile devices in this group. In case the mobile devices exceed a certain number, the wireless network has to renew the key of each of the mobile devices more frequently, causing an excessive overhead.

Accordingly, there is an urgent need in the art to reduce the overhead of wireless networks in key renewing.

### SUMMARY OF THE INVENTION

One objective of this invention is to provide a key renewing method. The method is adapted to a first base station that belongs to a wireless network. The first base station uses a first key and has a first coverage. The method comprises the following steps: (a) determining that a mobile device moves from a second coverage of a second base station to the first coverage, wherein the first coverage and the second coverage partially overlap with each other, the second base station belongs to the wireless network, and the second base station uses a second key; (b) determining that a login time of the mobile device is later than a renewal time of the first key; (c) renewing the first key in response to the step (b); and (d) transmitting the renewed first key to the mobile device.

Another objective of this invention is to provide a key renewing apparatus. The key renewing apparatus is adapted to a first base station. The first base station has a first coverage and belongs to a wireless network. The key renewing apparatus comprises a storage module, a process module, and a transmission module. The storage module is configured to store a first key of the first base station. The process module is configured to determine that a mobile device moves from a second coverage of a second base station to the first coverage, determine that a login time of the mobile device is later than a renewal time of the first key, and renews the first key in response to the determination result of the login time being later than the renewal time. The first and the second coverage partially overlap with each other. The second base station belongs to the wireless network and uses a second key. The transmission module is configured to transmit the renewed first key to the mobile device.

Yet a further objective of this invention is to provide a computer readable medium for storing a computer program for key renewing. The computer program is adapted to a first base station. The first base station belongs to a wireless network and uses a first key. The computer program executes codes A, B, C, and D after the computer program is loaded into a processor of the first base station. The code A enables the processor to determine that a mobile device moves from a second coverage of a second base station to the first coverage, wherein the first coverage and the second coverage partially overlap with each other, the second base station belongs to the wireless network, and the second base station uses a second key. The code B enables the processor to determine that a login time of the mobile device is later than a renewal time of the first key. The code C enables the processor to renew the first key after the processor has executed the code B. The code D enables the processor to transmit the renewed first key to the mobile device.

In particular, according to the disclosure of this invention, when a mobile device moves from a second coverage of a second base station to a first coverage of a first base station, the first base station determines whether to renew a first key it uses. If a login time of the mobile device logging in the wireless network is later than a renewal time of the first key, the first base station renews the first key immediately; otherwise, the key is not renewed. In this way, the number of key renewing operations in the wireless network is reduced.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a schematic view of a wireless network according to a first embodiment;

FIG. 2 depicts a schematic view of a key reviewing apparatus;

FIG. 3A depicts a partial flowchart of a key renewing method according to a second embodiment;

FIG. 3B depicts another partial flowchart of the key renewing method according to a second embodiment;

FIG. 4 depicts a schematic view that compares the wireless network of this invention with that of the prior art; and

FIG. 5 depicts a graph that compares the efficacy of this invention with that of the prior art.

### DESCRIPTION OF THE PREFERRED EMBODIMENT

In the following description, this invention will be explained with reference to embodiments thereof. This invention relates to a key renewing method and apparatus, and a wireless network comprising the key renewing method and apparatus. This invention divides the key renewing time points into real-time ones and non real-time ones. Key renewing operations at the non real-time points will be delayed to be processed in a batch at a subsequent real-time point to decrease the cost of key renewing. However, these embodiments are not intended to limit this invention to any specific environment, applications or particular implementations described in these embodiments. Therefore, the description of these embodiments is only for purposes of illustration rather than to limit this invention.

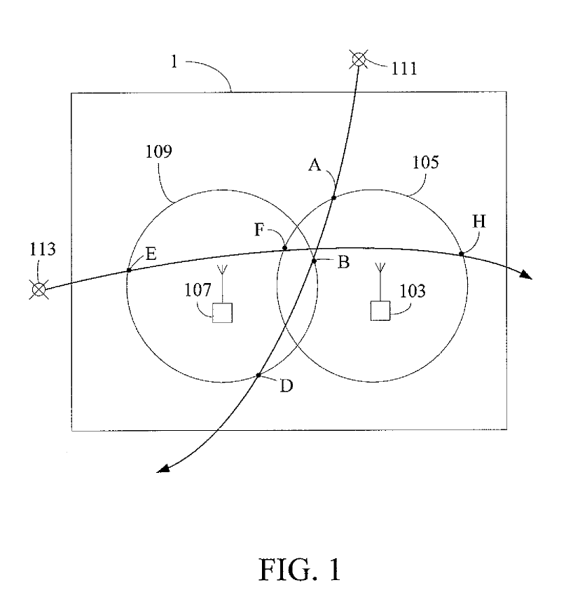

A first embodiment of this invention is a wireless network 1, a schematic view of which is depicted in FIG. 1. The wireless network 1 comprises a first base station 107 and a second base station 103. The first base station 107 has a first coverage 109, while the second base station 103 has a second coverage 105. The first coverage 109 and the second coverage 105 partially overlap. The first base station 107 uses a first key to encrypt messages to be transmitted therefrom. Hence, mobile devices within the first coverage 109 have to acquire the first key to decrypt the message transmitted by the first base station 107, while mobile devices that have left the first coverage 109 are not allowed to acquire the first key currently in use. Likewise, the second base station 103 uses a second key to encrypt messages to be transmitted therefrom. Hence, mobile devices within the second coverage 105 has to acquire the second key to decrypt the message transmitted by the second base station 103, while mobile devices that have left the second coverage 105 are not allowed to acquire the second key currently in use.

It should be noted that the terms “first” and “second” used in the first embodiment are only intended to refer to the two different base stations, the coverage of the two base stations, and the keys used by the two base stations, but have no other particular meanings.

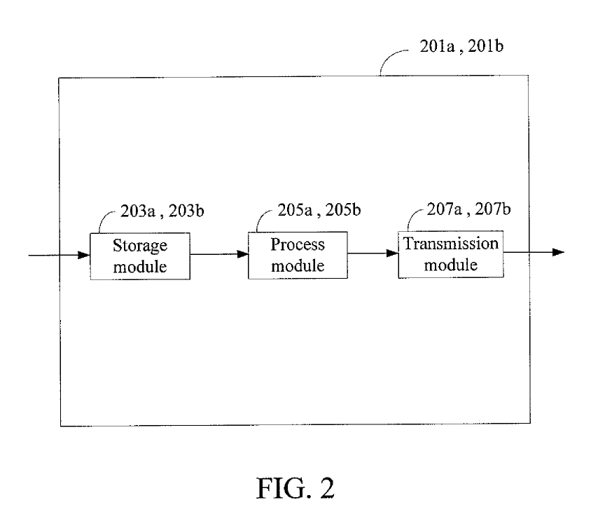

The first base station 107 and the second base station 103 are provided with a key renewing apparatus 201a, 201b respectively. FIG. 2 depicts a schematic view of the key renewing apparatuses 201a, 201b. The key renewing apparatus 201a comprises a storage module 203a, a process module 205a and a transmission module 207a, while the key renewing apparatus 201b comprises a storage module 203b, a process module 205b and a transmission module 207b. The storage module 203a of the first base station 107 is configured to store the first key, while storage module 203b of the second base station 103 is configured to store the second key.

Next, how the key renewing apparatus 201a of the first base station 107 renews the first key at an appropriate time and the key renewing apparatus 201b of the second base station 103 renews the second key at an appropriate time will be described.

As an example, a mobile device 113 enters the first coverage 109 of the first base station 107 from a location E at 9:00 a.m. At this moment, the process module 205a of the first base station 107 determines that the mobile device 113 has not entered the first coverage 109 or the second coverage 105 until 9:00 a.m., so it ascertains that the mobile device 113 logs into the wireless network 1 at this time point. In the first base station 107, the time at which the mobile device logs into the wireless network 1 is set as a real-time renewing time point, so the process module 205a of the first base station 107 renews the first key accordingly. The storage module 203a then stores the renewed first key (renewed at 9:00 a.m.). Furthermore, the transmission module 207a transmits the renewed first key (renewed at 9:00 a.m.) to the mobile device 113. On the other hand, the mobile device 113 records 9:00 a.m. as its login time in the wireless network 1, while the storage module 203a records that the mobile device 113 has entered the first coverage 109.

Subsequently, a mobile device 11 enters the second coverage 105 of the second base station 103 from a location A at 9:20 a.m. At this moment, the process module 205b of the second base station 103 determines that the mobile device 111 has not entered the first coverage 109 or the second coverage 105 until 9:20 a.m., so it ascertains that the mobile device 111 logs into the wireless network 1 at this time point. In the second base station 103, the time at which the mobile device 111 logs in the wireless network 1 is set as a real-time renewing time point, so the process module 205b of the second base station 103 renews the second key accordingly. The storage module 203b then stores the renewed second key (renewed at 9:20 a.m.). Furthermore, the transmission module 207b transmits the renewed second key (renewed at 9:20 a.m.) to the mobile device 111. On the other hand, the mobile device 111 records 9:20 a.m. as its login time in the wireless network 1, while the storage module 203b records that the mobile device 111 has entered the second coverage 105.

Then, the mobile device 113 moves to a location F at 9:30 a.m. At this moment, the process module 205b of the second base station 103 determines that the mobile device 113 is moving from the first coverage 109 into the second coverage 105. The process module 205b of the second base station 103 determines that the login time (9:00 a.m.) of the mobile device 113 in the wireless network 1 is earlier than the renewal time (9:20 a.m.) of the second key. In the second base station 103, when the login time of the mobile device in the wireless network is earlier than the renewal time of the second key, it means that this time point is a non real-time renewing time point, so the process module 205b does not renew the second key at this moment. Then, the transmission module 207b of the second base station 103 transmits the second key (renewed at 9:20 a.m.) to the mobile device 113. On the other hand, as the mobile device 113 has left the first coverage 109 of the first base station 107, the storage module 203a of the first base station 107 records that the mobile device 113 has left the first coverage 109 and has once acquired the first key.

At 9:50 a.m., the mobile device 111 moves to a location B. At this moment, the process module 205a of the first base station 107 determines that the mobile device 111 is moving from the second coverage 105 of the second base station 103 into the first coverage 109 of the first base station 107. Then, the process module 205a of the first base station 107 determines that the login time (9.20 a.m.) of the mobile device 111 in the wireless network 1 is later than the renewal time (9:00 a.m.) of the first key. In the first base station 107, a time point that the login time of the mobile device in the wireless network is later than the renewal time of the first key is considered as a real-time renewing time point, so the process module 205a renews the first key immediately in response to this determination result. Accordingly, the storage module 203a stores the renewed first key (renewed at 9:50 a.m.), and the transmission module 207a transmits the first key (renewed at 9:50 a.m.) to the mobile device 111. On the other hand, as the mobile device 111 has left the second coverage 105 of the second base station 103, the storage module 203b of the second base station 103 records that the mobile device 111 has left the second coverage 105 and has once acquired the second key.

At 10:00 a.m., the mobile device 113 moves to a location H. The process module 205b of the second base station 103 determines that the mobile device 113 is leaving the second coverage 105 and determines that the mobile device 113 logs off the wireless network 1 via the second base station 103. At this moment, the storage module 203b records that the mobile device 113 has left the second coverage 105 and has once acquired the second key.

Then, the process module 205a determines whether the first base station 107 has renewed the first key after the mobile device 113 left the first coverage 109. In the first base station, if it is determined that the first base station 107 has not renewed the first key yet after the mobile device 113 left the first coverage 109, it means that this time point is a real-time renewing time point. Because the mobile device 113 left the first coverage at 9:30 a.m. and the first key was renewed at 9:50 a.m., the process module 205a of the first base station 107 does not renew the first key.

On the other hand, the process module 205b determines whether the second base station 103 has renewed the second key after the mobile device 113 left the second coverage 105. In the second base station, if it is determined that the second base station 103 has not renewed the second key yet after the mobile device 113 left the second coverage 105, it means that this time point is a real-time renewing time point. Because the mobile device 113 left the second coverage 105 at 10:00 a.m. and the second key was renewed at 9:20 a.m., the process module 205b of the second base station 103 renews the second key. The storage module 203b of the second base station 103 then stores the renewed second key (renewed at 10:00 a.m.) accordingly.

At 10:20 a.m., the mobile device 111 moves to a location D. The process module 205a of the first base station 107 determines that the mobile device 111 is leaving the first coverage 109 and determines that the mobile device 111 logs off the wireless network 1 via the first base station 107. At this moment, the storage module 203a records that the mobile device 111 has left the first coverage 109 and has once acquired the first key.

Then, the process module 205a of the first base station 107 determines whether the first base station 107 has renewed the first key after the mobile device 111 left the first coverage 109. Because the mobile device Ill left the first coverage 109 at 10:20 a.m. and the first key was renewed at 9:50 a.m., it is understood that the first base station 107 has not renewed the first key yet after the mobile device 111 left the first coverage 109. Therefore, the process module 205a of the first base station 107 renews the first key, and the storage module 203a stores the renewed first key (renewed at 10:20 a.m.) accordingly.

On the other hand, the process module 205a determines whether the second base station 103 has renewed the second key after the mobile device 111 left the second coverage 105. Because the mobile device 111 left the second coverage 105 at 9:50 a.m. and the second key was renewed at 10:00 a.m., it is understood that the second base station 103 has renewed the second key after the mobile device 111 left the second coverage 105. Therefore, the process module 205b of the second base station 103 does not renew the second key.

In the first embodiment, during the interval between the mobile device 113 logs in and logs off the wireless network 1, key renewing in the wireless network 1 occurs twice. During the interval between the mobile device 111 logs in and logs off of the wireless network 1, key renewing in the wireless network 1 occur three times. In contrast, if the technology of the prior art (i.e., key renewing occurs each time a mobile device enters or leaves the coverage of a base station) were adopted, key renewing would occur four times during the interval between the mobile device 113 logs in and logs off of the wireless network 1, as would also be the case for the mobile device 111. It can be seen that the first embodiment reduces the number of key renewing operations remarkably.

It can be known from the above description that in the first embodiment, each of the base stations (i.e., the first base station 107 and the second base station 103) belonging to the wireless network 1 distinguishes the key renewing time points into real-time ones and non real-time ones. In particular, when a mobile device logs in the wireless network 1 via a target base station (either the first base station 107 or the second base station 103), the time point is a real-time key renewing time point and, accordingly, the target base station renews the key it uses (either the first or the second key) immediately.

On the other hand, when the mobile device enters a coverage of a target base station from a coverage of an original base station (e.g., enters the second coverage 105 of the second base station 103 from the first coverage 109 of the first base station 107, or enters the first coverage 109 of the first base station 107 from the second coverage 105 of the second base station 103), the target base station may not have to renew the key it uses immediately. In more detail, the target base station will compare the most recent renewing time point of the key it uses with the login time of the mobile device in the wireless network 1 to determine whether this time point is a real-time one or a non real-time one. If the login time of the mobile device in the wireless network 1 is the later one, then this key renewing time point is a real-time one and the target base station has to renew the key it uses immediately. Otherwise, if the login time of the mobile device in the wireless network 1 is the earlier one, then this key renewing time point is a non real-time one, in which case the key needs not to be renewed.

After the mobile device has logged off the wireless network 1, each of the base stations (i.e., the first base station 107 and the second base station 103) has to determine whether the key thereof has been renewed since the mobile device left the coverage thereof If not, the key must be renewed at this time point.

It should be emphasized that the number of base stations in the wireless network 1 is not limited. If the wireless network 1 further comprises more base stations, these more base stations also make the same determination. Hence, the number of key renewing operations can be reduced no matter how many base stations are included in the wireless network 1.

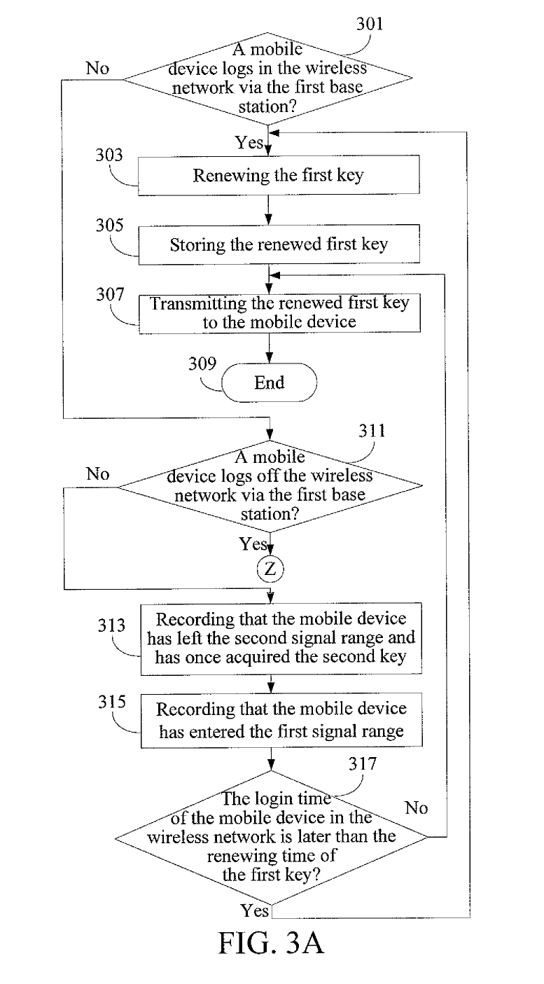

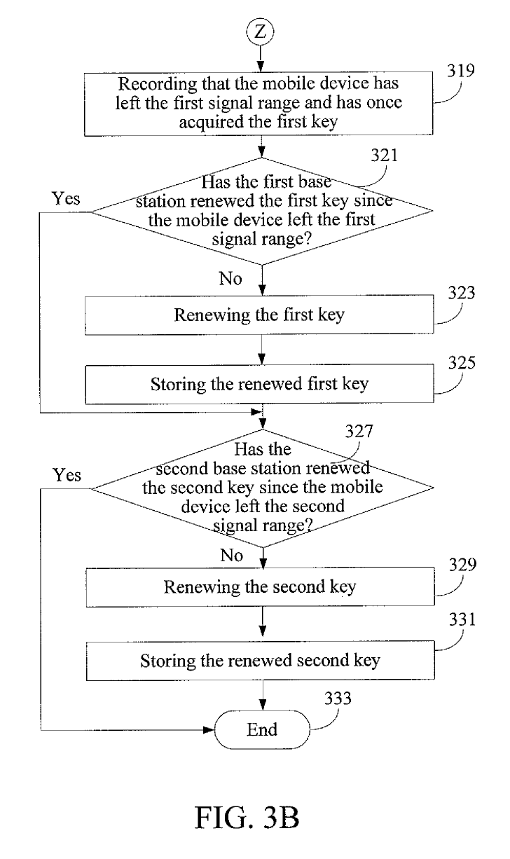

The second embodiment of this invention is a key renewing method, a flowchart of which is depicted in FIG. 3A. As with the first embodiment, the second embodiment also divides key renewing time points into real-time ones and non real-time ones. If a key renewing time point is a non real-time one, the key renewing operation will be delayed to be processed in batch at a subsequent real-time key renewing time point to reduce overhead caused to the wireless network by key renewing.

The key renewing method of the second embodiment is adapted for all base stations in a wireless network. For convenience, two base stations will be described in the second embodiment as an example. However, it should be appreciated that the number of base stations is not intended to limit the scope of this invention. The two base stations in the second embodiment are named as the first base station and second base station respectively. The first base station has a first coverage, while the second base station has a second coverage. The first coverage and the second coverage partially overlap. The first base station uses a first key, and the second base station uses a second key. In the second embodiment, the terms “first” and “second” are only intended to mean two different base stations, the coverage of the two base stations, and the keys used by the two base stations, but have no other particular meanings. In the following description, the key renewing method of the second embodiment will be described from the viewpoint of the first base station. However, in practical operation, the second base station adopts the same key renewing method as well.

Initially in Step 301, the first base station determines whether a mobile device has logged in the wireless network via the first base station. If it is yes in Step 301, the first base station renews the first key in Step 303 and stores the renewed first key in Step 305. Next, the first base station transmits the renewed first key to the mobile device in Step 307. Then, the process proceeds to Step 309 to conclude the key renewing method.

If it is not in Step 301, the first base station executes Step 311 to determine whether a mobile device has logged off the wireless network via the first base station. If it is not in Step 311, it means that the first base station ascertains that a mobile device enters the first coverage of the first base station from the second coverage of the second base station. Next, the second base station executes Step 313 to record that the mobile device has left the second coverage, while the first base station executes Step 315 to record that the mobile device has entered the first coverage.

The first base station then executes Step 317 to determine whether the login time of the mobile device in the wireless network is later than the renewing time of the first key. If so, the first base station renews the first key in Step 303 and stores the renewed first key in Step 305. Furthermore, the first base station transmits the renewed first key to the mobile device in Step 307. Subsequently, the key renewing method ends in Step 309. Otherwise, if not, the first base station transmits the first key to the mobile device directly in Step 307. Then the key renewing method ends in Step 309.

If it is yes in step 311, it means that the first base station determines that the mobile device has left the first coverage and logged off the wireless network. FIG. 3B depicts a flowchart of subsequent operations. The first base station executes Step 319 to record that the mobile device has left the first coverage and has once acquired the first key. Next in Step 321, the first base station determines whether the first key has been renewed after the mobile device left the first coverage. If not, the first key is renewed in Step 323 while the renewed first key is stored in Step 325. Afterwards, the second base station executes Step 327. Otherwise, if the key has been renewed in Step 321, the second base station executes Step 327 directly.

In Step 327, the second base station determines whether the second key has been renewed since the mobile device left the second coverage. If not, the second base station 329 renews the second key in Step 329 and stores the renewed second key in Step 331. Finally, the key renewing process ends in Step 333. Otherwise, if the determination result is yes in Step 327, Step 333 is executed directly to end the key renewing method.

In addition to the aforesaid steps, the second embodiment can also execute all the operations and functions of the wireless network of the first embodiment. The second embodiment executes these operations and functions in methods that will be readily appreciated by those of ordinary skill in the art based on the explanation of the wireless network in the first embodiment, and thus will not be further described herein.

A third embodiment of this invention is a computer readable medium that stores a computer program for key renewing. This computer readable medium is adapted for a wireless network comprising a first base station and a second base station. The first base station has a first coverage, while the second base station has a second coverage. The first coverage and the second coverage partially overlap. The first base station uses a first key, while the second base station uses a second key. After being loaded into respective processors of the first base station and the second base station, the computer program executes a plurality of codes to enable the processors to accomplish the steps of the second embodiment described above. This computer readable medium may be a floppy disk, a hard disk, a compact disk, a mobile disk, a magnetic tape, a database accessible to the Internet, or any other storage media with the same function and well known to those skilled in the art.

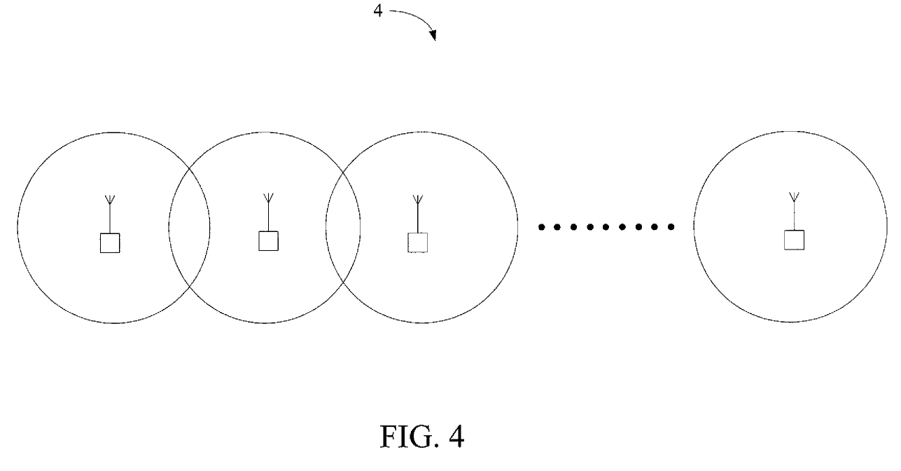

FIG. 4 depicts an example of a wireless network 4 that compares the efficacy of this invention with that of the prior art solution. The wireless network 4 comprises N base stations, each of which has a coverage. The coverage of the base stations are overlapped in a way as shown in FIG. 4. Assume that a mobile device moves in such a way that it logs into the wireless network 4 via the leftmost base station, then moves rightwards through each of the base stations in sequence, and finally logs off the wireless network 4 via the rightmost base station. Additionally, it is assumed that overhead caused by each key renewing is M.

If the prior art solution is adopted, a base station has to renew a key it uses each time a mobile device enters or leaves a coverage of the base station. As the mobile device moves along the aforesaid path, the overhead caused by key renewing in the wireless network 4 is 2*N*M.

In contrast, by using this invention, in the best case, the wireless network 4 renews respective keys only when the mobile device logs in the wireless network 4 via the leftmost base station and logs off the wireless network 4 via the rightmost base station, so the overhead caused by key renewing is 2*M. In the worst case, there is only a single mobile device in the wireless network 4, so in addition to the key renewing operations associated with the aforesaid login and logout, the base stations also have to renew respective keys whenever the mobile device is handed over between the base stations. In this case, the overhead caused by key renewing is 2*N*M.

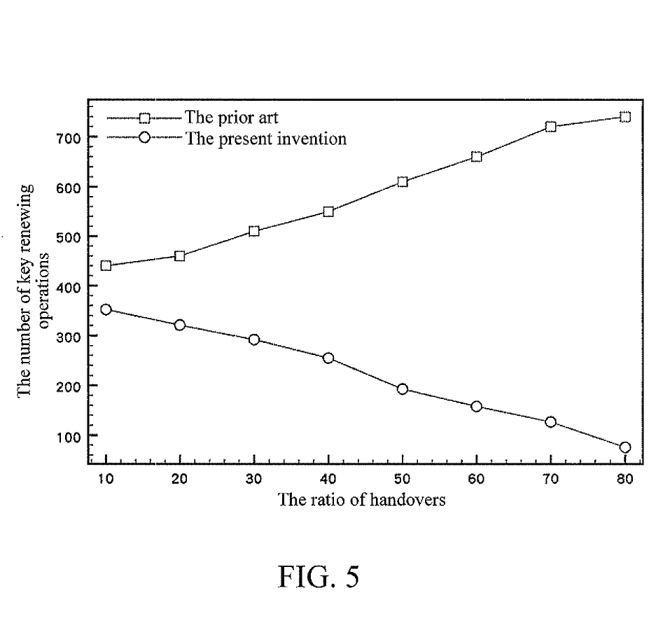

FIG. 5 is a graph that compares the efficacy of the prior art solution with that of this invention. The simulated environment is a wireless network having three base stations. Originally, there are 50 mobile devices in the coverage of each of the base stations. Cases in which the 150 mobile devices logged in and off the wireless network and are handed over between the base stations are simulated according to the users' behaviors. In FIG. 5, the horizontal axis represents a ratio of handovers between the base stations, while the vertical axis represents the number of key renewing operations. It can be seen from FIG. 5 that the number of key renewing operations needed in this invention is smaller than that of the prior art irrespective of the ratio of handovers between base stations. Additionally, the higher the ratio of handovers between the base stations, the more significant the reduction in the number of key renewing operations.

In summary, according to the disclosure of this invention, a target base station determines whether to renew a key it uses when a mobile device moves from the coverage of an original base station to the coverage of the target base station. If the login time of the mobile device logging into the wireless network is later than the renewing time of the key of the target base station, the target base station renews the key immediately; otherwise, the key is not renewed. In this way, the number of key renewing operations in the wireless network is reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A key renewing method, the method being adapted to a first base station, the first base station belonging to a wireless network, the first base station using a first key and having a first coverage, the method comprising the steps of:
(a) determining that a mobile device moves from a second coverage of a second base station to the first coverage, the first coverage and the second coverage partially overlapping, the second base station belonging to the wireless network, and the second base station using a second key;
(b) determining that a login time of the mobile device logging in the wireless network is later than a renewal time of the first key;
(c) renewing the first key in response to the step (b); and
(d) transmitting the renewed first key to the mobile device.

2. The key renewing method of claim 1, further comprising the step of:
recording that the mobile device has acquired the second key and the mobile device has left the second coverage after the step (a).

3. The key renewing method of claim 1, further comprising the step of:
recording the mobile device having entered the first coverage after the step (a).

4. The key renewing method of claim 1, further comprising the steps of:
(e) determining that the mobile device has left the first coverage; and
(f) recording that the mobile device has acquired the first key and the mobile device has left the first coverage.

5. The key renewing method of claim 4, further comprising the steps of:
(g) determining that the mobile device logs off the wireless network via the first base station;
(h) determining that the first base station has not renewed the first key after the mobile device left the first coverage after the step (g); and
(i) renewing the first key in response to the step (h).

6. The key renewing method of claim 5, further comprising the steps of:
(j) determining that the second base station has not renewed the second key after the mobile device left the second coverage after the step (g); and
(k) renewing the second key in response to the step (j).

7. The key renewing method of claim 4, further comprising the steps of:
(g) determining that the mobile device logs off the wireless network via the first base station;
(h) determining that the second base station has not renewed the second key after the mobile device left the second coverage after the step (g); and
(i) renewing the second key in response to the step (h).

8. A key renewing apparatus, the apparatus being adapted to a first base station, the first base station having a first coverage, the first base station belonging to a wireless network, the apparatus comprising:
a storage module, being configured to store a first key of the first base station;
a process module, being configured to determine that a mobile device moves from a second coverage of a second base station to the first coverage, determine that a login time of the mobile device logging in the wireless network is later than a renewal time of the first key, and renew the first key according to the determination result, wherein the first coverage and the second coverage partially overlap, the second base station belongs to the wireless network, and the second base station uses a second key; and
a transmission module, being configured to transmit the renewed first key to the mobile device.

9. The key renewing apparatus of claim 8, wherein the storage module is further configured to record the mobile device having entered the first coverage.

10. The key renewing apparatus of claim 8, wherein the process module is further configured to determine that the mobile device has left the first coverage, and the storage module is further configured to record that the mobile device has acquired the first key and the mobile device has left the first coverage.

11. The key renewing apparatus of claim 10, wherein the process module is further configured to determine that the mobile device logs off the wireless network via the first base station, determine that the first base station has not renewed the first key after the mobile device left the first coverage, and renew the first key.

12. A computer readable medium for storing a computer program for key renewing, the computer program being adapted to a first base station, the first base station belonging to a wireless network, the first base station using a first key, the computer program executing the following codes after the computer program being loaded to a processor of the first base station:
code A for enabling the processor to determine that a mobile device moves from a second coverage of a second base station to the first coverage, the first coverage and the second coverage partially overlapping, the second base station belonging to the wireless network, and the second base station using a second key;
code B for enabling the processor to determine that a login time of the mobile device is later than a renewal time of the first key;
code C for enabling the processor to renew the first key after the processor has executed the code B; and
code D for enabling the processor to transmit the renewed first key to the mobile device.

13. The computer readable medium of claim 12, wherein the computer program further executes:
code E for enabling the processor used to record that the mobile device has left the second coverage and the mobile device has acquired the second key after the processor has executed the code A.

14. The computer readable medium of claim 12, wherein the computer program further executes
code E for enabling the processor used to record the mobile device having entered the first coverage after the processor has executed the code A.

15. The computer readable medium of claim 12, wherein the computer program further executes:
code E for enabling the processor to determine that the mobile device has left the first coverage; and
code F for enabling the processor to record that the mobile device has acquired the first key and the mobile device has left the first coverage.

16. The computer readable medium of claim 15, wherein the computer program further executes:
code G for enabling the processor to determine that the mobile device logs off the wireless network via the first base station;
code H for enabling the processor to determine that the first base station has not renewed the first key after the mobile device has left the first coverage after the processor has executed the code F; and
code I for enabling the processor to renew the first key after the processor has executed t the code H.

17. The computer readable medium of claim 16, wherein the computer program further executes:
code J for enabling the processor to determine that the second base station has not renewed the second key after the mobile device has left the second coverage after the processor has executed the code G; and
code K for enabling the processor to renew the second key after the processor has executed the code J.

18. The computer readable medium of claim 15, wherein the computer program further executes:
code G for enabling the processor to determine that the mobile device logs off the wireless network via the first base station;
code H for enabling the processor to determine that the second base station has not renewed the second key after the mobile device has left the second coverage after the processor has executed the code G; and
code I for enabling the processor to renew the second key after the processor has executed the code H.

19. A wireless network, comprising:
a first base station, having a first coverage and using a first key; and
a second base station, having a second coverage and using a second key, wherein the first coverage and the second coverage partially overlap;
wherein the first base station determines that a mobile device moves from the second coverage to the first coverage, the first base station determines that a login time of the mobile device logging in the wireless network is later than a renewal time of the first key, the first base station renews the first key according to the determination result, and the first base station transmits the renewed first key to the mobile device.

20. The wireless network of claim 19, wherein the second base station is further configured to record the mobile device having left the second coverage and the mobile device having acquired the second key after the mobile device has left the second coverage.

21. The wireless network of claim 19, wherein the first base station is further configured to record the mobile device having entered the first coverage after the mobile device has entered the first coverage.

22. The wireless network of claim 19, wherein the first base station is further configured to determine that the mobile device has left the first coverage and record that the mobile device has acquired the first key and the mobile device has left the first coverage.

23. The wireless network of claim 22, wherein the first base station is further configured to determine that the mobile device logs off the wireless network via the first base station, determine that the first base station has not renewed the first key after the mobile device left the first coverage, and renew the first key.

24. The wireless network of claim 23, wherein the second base station is further configured to determine that the second base station has not renewed the second key after the mobile device left the second coverage and renewing the second key.

25. The wireless network of claim 22, wherein the first base station is further configured to determine that the mobile device logs off the wireless network via the first base station, the second base station is further configured to determined that the second base station has not renewed the second key after the mobile device left the second coverage, and the second base station is further configured to renew the second key.
